(19) United States
(12) Patent Application Publication
(10) Pub. No.: US 2018/0195639 A1
(43) Pub. Date: Jul. 12, 2018

(54) VACUUM VALVE

(71) Applicant: SHIMADZU CORPORATION, Kyoto (JP)

(72) Inventor: Masahito KOGAME, Kyoto (JP)

(21) Appl. No.: 15/863,934

(22) Filed: Jan. 7, 2018

(30) Foreign Application Priority Data
Jan. 12, 2017 (JP) 2017-003449

(51) Int. Cl. F16K 41/02; F16K 3/02

(52) U.S. Cl. CPC F16K 41/023; F16K 3/0281

(57) ABSTRACT

A vacuum valve comprises: a valve body configured to house a valve plate; a drive shaft configured to openably/closably drive the valve plate; a shaft seal configured to vacuum-seal the drive shaft; and an entrance prevention wall configured to prevent a particle from entering the shaft seal.

### BACKGROUND OF THE INVENTION

### 1. Technical Field

The present invention relates to a vacuum valve.

### 2. Background Art

A vacuum valve has been known, which is configured to swingably drive a valve plate fixed to a drive shaft to perform opening/closing operation (see, e.g., Patent Literature 1 (JP-A-2011-137537)). The drive shaft is provided with a shaft seal for the purpose of vacuum sealing.

In a case where a vacuum device using the vacuum valve is a device configured to perform a film formation process, a product is generated by the film formation process. For this reason, particles are dropped into the vacuum valve attached between the vacuum device and a vacuum pump. When the particles enter a shaft seal portion, rotation failure or vacuum sealing failure might be caused.

### SUMMARY OF THE INVENTION

A vacuum valve comprises: a valve body configured to house a valve plate; a drive shaft configured to openably/closably drive the valve plate; a shaft seal configured to vacuum-seal the drive shaft; and an entrance prevention wall configured to prevent a particle from entering the shaft seal.

The vacuum valve further comprises: a seal holding member configured to hold the shaft seal. A valve-body-side end portion of the seal holding member protrudes from an inner peripheral surface of the valve body to form the entrance prevention wall.

The valve body is provided with a through-hole, the drive shaft penetrating the through-hole and the shaft seal being arranged in the through-hole, and the entrance prevention wall is provided at a periphery of the through-hole to protrude from the inner peripheral surface of the valve body.

A portion of the valve plate fixed to the drive shaft faces an entire area of an end surface of the entrance prevention wall in a protruding direction thereof.

According to the present invention, reliability of the vacuum valve can be improved.

### BRIEF DESCRIPTION OF THE DRAWINGS

FIG. 1 is a perspective view of an outer appearance of a vacuum valve of a first embodiment;

FIG. 2 is a view of one example of a sealing structure of a drive shaft;

FIGS. 3A and 3B are views of a second embodiment of a vacuum valve of the present invention;

FIGS. 4A and 4B are views of a third embodiment of a vacuum valve of the present invention; and

FIG. 5 is a view of one example of a typical configuration.

### DETAILED DESCRIPTION OF THE EXEMPLARY EMBODIMENTS

Hereinafter, embodiments of the present invention will be described with reference to the drawings.

### First Embodiment

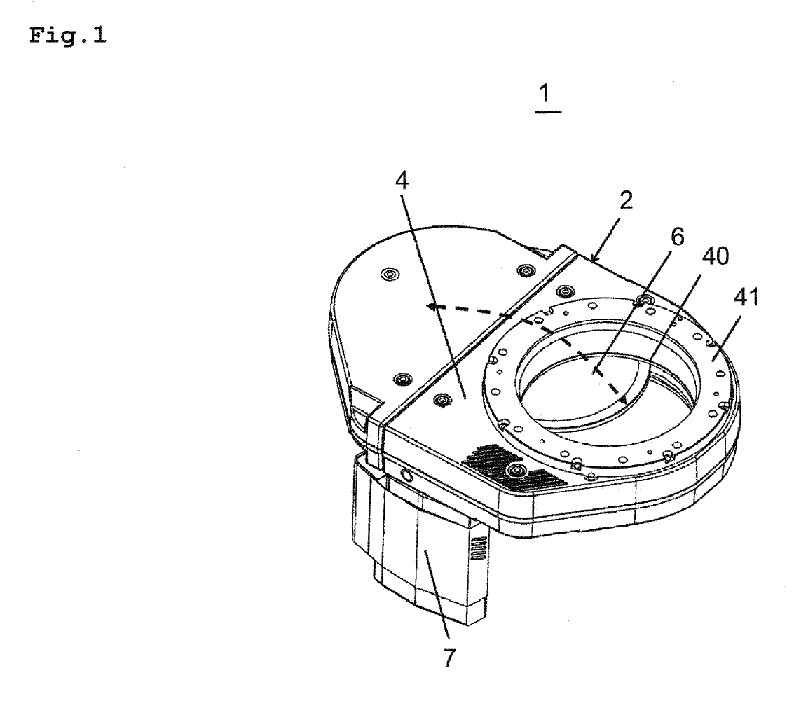

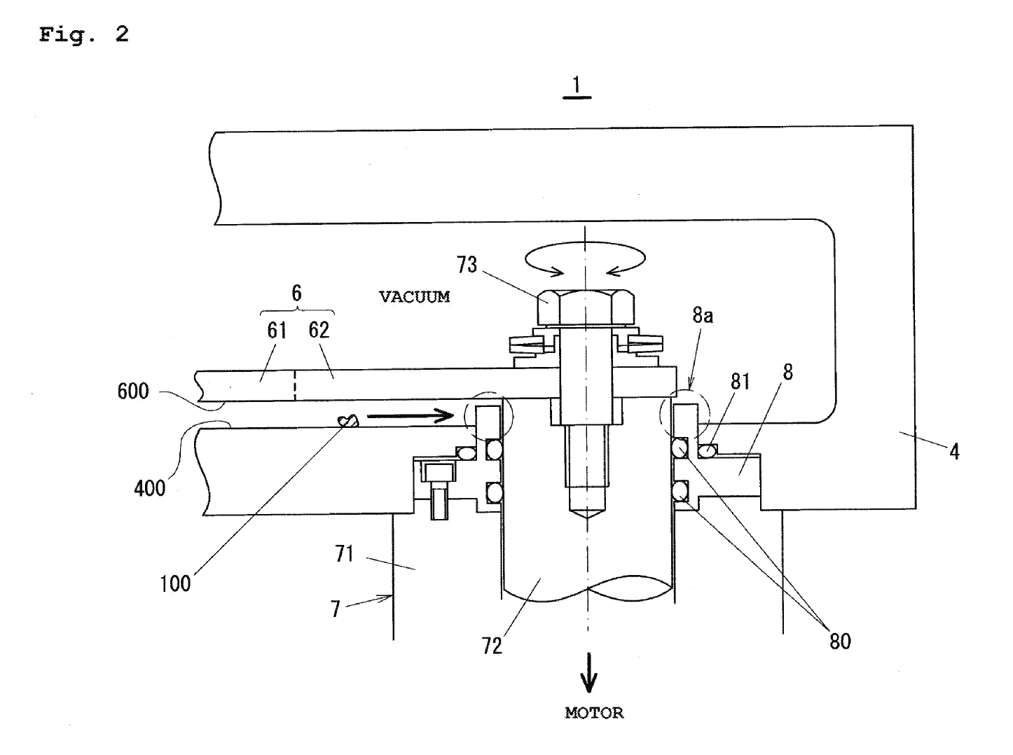

FIGS. 1 and 2 are views for describing a first embodiment of a vacuum valve of the present invention. FIG. 1 is a perspective view of an outer appearance of a vacuum valve 1. The vacuum valve 1 includes a valve main body 2 provided with a valve plate 6, and a drive section 7 configured to openably/closably drive the valve plate 6. A valve body 4 is provided with a valve opening 40. A suction port flange 41 is provided on a suction port side of the valve opening 40, i.e., the upper side of the valve body 4 as viewed in the figure. On the other hand, an exhaust port flange is provided on an exhaust side of the valve opening 40, i.e., the back side of the valve body 4 as viewed in the figure. The valve plate 6 is swingably driven as indicated by a dashed arrow by a motor provided at the drive section 7.

FIG. 2 is the view for illustrating a sealing structure of a drive shaft configured to drive the valve plate 6. A motor (not shown) configured to rotatably drive a drive shaft 72 is provided in a case 71 of the drive section 7 provided on the back side of the valve body 4. The valve plate 6 is fixed to an upper end of the drive shaft 72 with a fixing bolt 73. Note that the valve plate 6 includes a circular blocking portion 61 for opening/closing the valve opening 40, and a support portion 62 formed to extend from the blocking portion 61 in a radial direction. A tip end portion of the support portion 62 is fixed to the drive shaft 72. When the drive shaft 72 is rotatably driven by the motor, the valve plate 6 is swingably driven as indicated by the dashed arrow of FIG. 1. As a result, the valve opening 40 is opened/closed by the blocking portion 61 of the valve plate 6.

The case 71 is provided with a seal case 8 configured to hold shaft seals 80. The drive shaft 72 penetrates a through-hole of the seal case 8, and protrudes into the valve body 4. Moreover, a vacuum seal 81 is also provided between the seal case 8 and the valve body 4. Upon valve use, the inside of the valve body 4 is in a vacuum state. As described above, the shaft seals 80 configured to seal the drive shaft 72 and the seal 81 configured to seal between the seal case 8 and the valve body 4 are provided.

An upper end of the seal case 8 in an axial direction is provided with a ring-shaped protrusion 8a, the protrusion 8a protruding from an inner peripheral surface 400 of the valve body 4. The protruding amount of the protrusion 8a is set such that a gap dimension between an upper end of the protrusion 8a and a back surface 600 of the valve plate 6 is about 1 mm. Alternatively, the protruding amount is set to about 1 mm, considering an average size of a particle 100. There is a probability that the particle 100 having entered the valve body 4 moves, by the force of gravity, a gas flow, etc., toward a drive shaft side as indicated by an arrow.

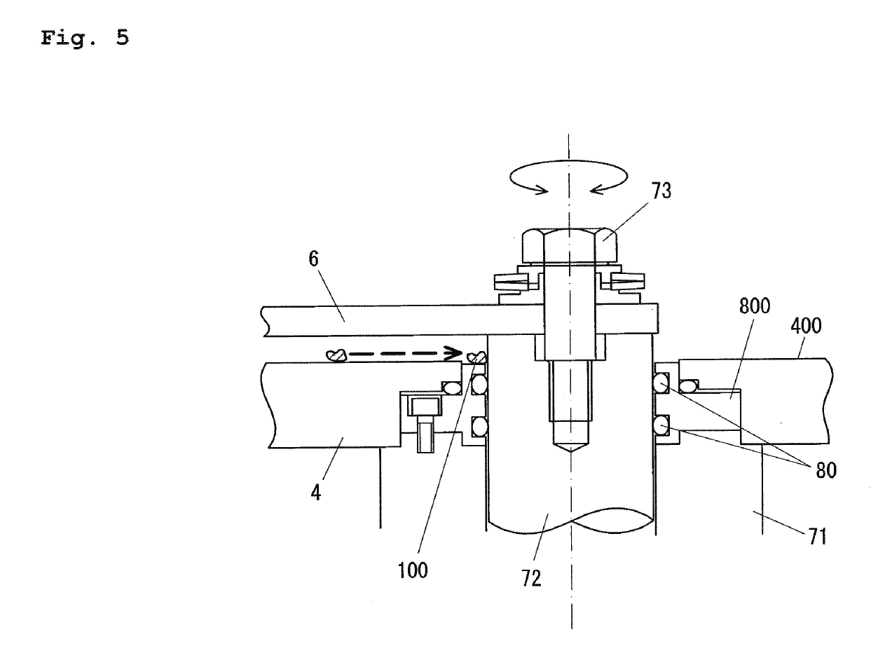

However, in the present embodiment, the protrusion 8a is provided at the seal case 8. This can prevent the particle 100 from entering a shaft seal portion of the drive shaft 72. As described above, the protrusion 8a functions as a blocking portion against entrance of the particle 100. FIG. 5 is a view of one example of a typical configuration. An upper end of a seal case 800 is recessed lower than an inner peripheral surface 400 of a valve body 4. In the case of such a structure, a particle 100 easily enters a shaft seal portion of a drive shaft 72.

(1) As described above, the vacuum valve 1 of the present embodiment includes the valve body 4 configured to house the valve plate 6, the drive shaft 72 configured to openably/closably drive the valve plate 6, the shaft seals 80 configured to vacuum-seal the drive shaft 72, and the protrusion 8a as an entrance prevention wall for preventing the particle 100 from entering the shaft seals 80. Thus, even in a case where the particle 100 moves toward the drive shaft 72, such movement is blocked by the protrusion 8a. This can prevent the particle 100 from entering the shaft seals 80. As a result, operation failure of the vacuum valve 1 due to the particle 100 can be prevented, leading to improvement of reliability of the vacuum valve 1.

(2) Note that the vacuum valve 1 of the present embodiment is a vacuum valve configured to include the seal case 8 as a seal holding member configured to hold the shaft seals 80. A valve-body-side end portion of the seal case 8 protrudes from the inner peripheral surface 400 of the valve body 4 such that the protrusion 8a forms the entrance prevention wall. As described above, a portion of the seal case 8 also serves as the entrance prevention wall so that a cost increase can be suppressed.

### Second Embodiment

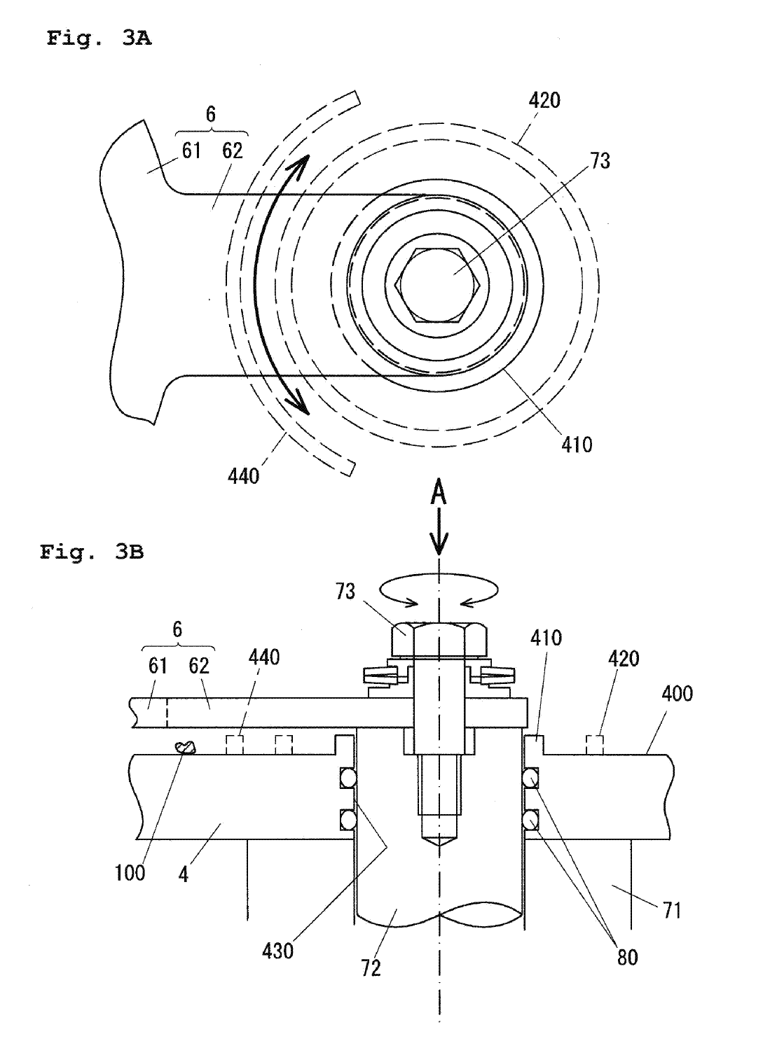

FIGS. 3A and 3B are views of a second embodiment of a vacuum valve of the present invention. The vacuum valve 1 of the first embodiment as described above includes the seal case 8 configured to hold the shaft seals 80. On the other hand, the second embodiment has such a structure that shaft seals 80 are directly provided at a valve body 4 as illustrate in FIGS. 3A and 3B.

In FIGS. 3A and 3B, FIG. 3B is the view for illustrating a sealing structure of a drive shaft 72, and FIG. 3A is the view from an arrow A. The drive shaft 72 penetrates a through-hole of the valve body 4 to protrude into the valve body 4. As in the case of FIG. 2, a valve plate 6 is fixed to a protruding upper end of the drive shaft 72. The shaft seals 80 configured to seal between the valve body 4 and an outer peripheral surface of the drive shaft 72 are provided in a through-hole 430 of the valve body 4. The inner peripheral surface 400 of the valve body 4 is provided with a ring-shaped protrusion 410, the protrusion 410 being configured to prevent a particle 100 from entering the shaft seals 80. The protruding amount of the protrusion 410 is similarly set as in the above-described case of the protrusion 8a.

Note that instead of forming the ring-shaped protrusion 410 at the through-hole 430, a ring-shaped protrusion 420 may be formed at a position apart from the through-hole 430. Note that as illustrated in FIG. 3A, a support portion 62 of the valve plate 6 does not cover an entire upper portion of the protrusion 410, 420. For this reason, when the protrusion 420 is extremely apart from the through-hole 430, there is a high probability that the particle 100 drops into an inner region of the protrusion 420.

In this embodiment, the protrusion 410, 420 is in the ring shape, and is not necessarily in the ring shape. For example, it may be configured such that a protrusion 440 configured to prevent particle entrance is provided at such an valve opening 40 that entrance of the particle 100 is highly likely to occur.

(3) In the above-described second embodiment, the through-hole 430 in which the shaft seals 80 are arranged and through which the drive shaft 72 penetrates is formed at the valve body 4. The protrusion 410 protruding from the inner peripheral surface 400 of the valve body 4 is provided at the periphery of the through-hole 430, and therefore, serves as an entrance prevention wall. Thus, even in a case where the particle 100 moves toward the drive shaft 72, such movement is blocked by the protrusion 410. This can prevent the particle 100 from entering the shaft seals 80. As a result, operation failure of the vacuum valve 1 due to the particle 100 can be prevented, leading to improvement of reliability of the vacuum valve 1.

### Third Embodiment

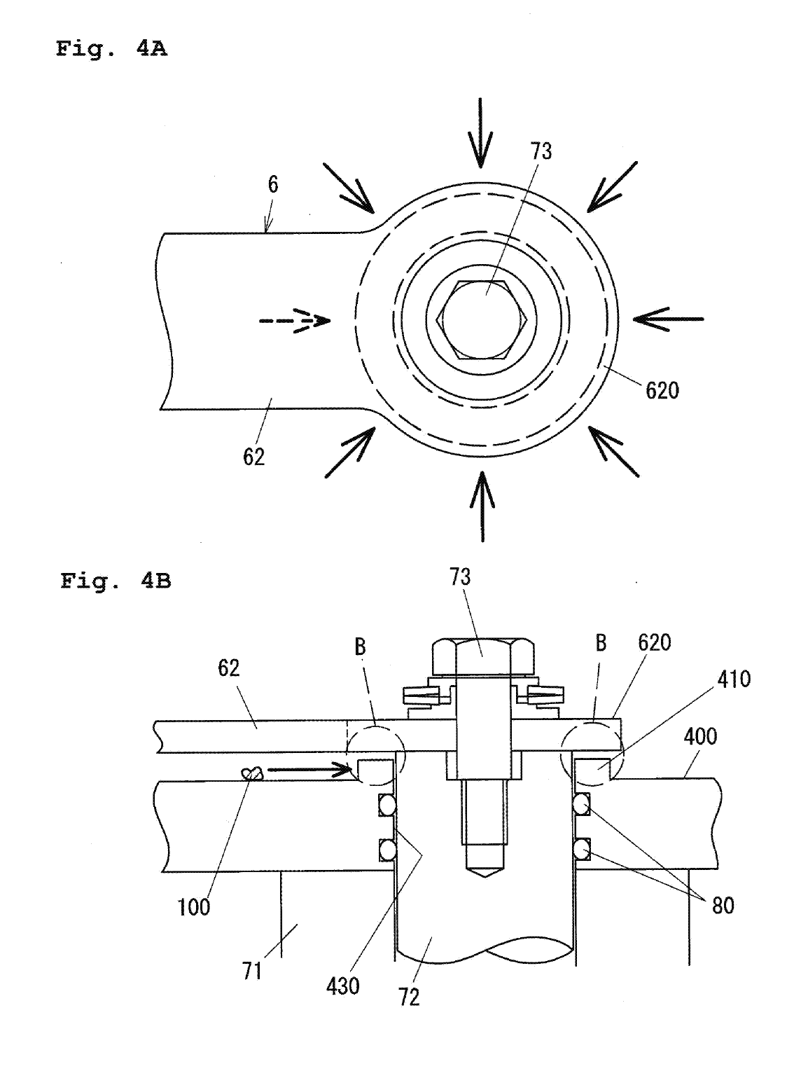

FIGS. 4A and 4B are views of a third embodiment of a vacuum valve of the present invention. As in the case of the second embodiment, shaft seals 80 are directly provided at a valve body 4 in the third embodiment. A ring-shaped protrusion 410 is formed at an inner peripheral surface 400 of the valve body 4. Further, a discoid opposing portion 620 facing the protrusion 410 is formed at a support portion 62 of a valve plate 6. The opposing portion 620 faces an entire area of the ring-shaped protrusion 410 across 360 degrees. Thus, even when the valve plate 6 is at any opening/closing position, an upper surface of the ring-shaped protrusion 410 is, across an entire region, covered with the opposing portion 620 at all times. In a region B where the protrusion 410 and the opposing portion 620 face each other, only a slight clearance is formed.

As described above, the opposing portion 620 faces the protrusion 410 through the slight clearance. Thus, even in a case where a particle 100 dropped onto the inner peripheral surface 400 moves toward a drive shaft 72 as indicated by an arrow of FIG. 4B, entrance into the shaft seals 80 can be prevented. Moreover, even in a case where the valve plate 6 is openably/closably driven, the opposing portion 620 faces the ring-shaped protrusion 410 across the entire circumference thereof. Thus, even in a case where the particle 100 moves from any direction as indicated by arrows of FIG. 4A, entrance into the shaft seals 80 can be prevented.

(4) As described above, in the third embodiment, the opposing portion 620 as a portion of the valve plate 6 fixed to the drive shaft 72 faces an entire area of an end surface of the protrusion 410 as an entrance prevention wall in a protruding direction thereof. Thus, the effect of preventing entrance of the particle 100 can be improved across 360 degrees around the drive shaft 72.

Note that for the configuration in which the protrusion 8a is formed at the seal case 8 as illustrated in FIG. 2, the opposing portion 620 facing the protrusion 8a is also provided at the valve plate 6 so that similar advantageous effects can be provided.

In the above-described configuration illustrated in FIG. 2, an upper end portion (the protrusion 8a) of the seal case 8 protrudes from the inner peripheral surface 400 to serve as the entrance prevention wall. Instead of forming the protrusion 8a, it may be configured such that the protrusion 410, 420, 440 as illustrated in FIGS. 3A and 3B is provided.

The various embodiments and the variations have been described above, but the present invention is not limited to these contents. Other aspects conceivable within the scope of the technical idea of the present invention are also included in the scope of the present invention.

What is claimed is:

1. A vacuum valve comprising:
a valve body configured to house a valve plate;
a drive shaft configured to openably/closably drive the valve plate;
a shaft seal configured to vacuum-seal the drive shaft; and
an entrance prevention wall configured to prevent a particle from entering the shaft seal.

2. The vacuum valve according to claim 1, further comprising:
a seal holding member configured to hold the shaft seal,
wherein a valve-body-side end portion of the seal holding member protrudes from an inner peripheral surface of the valve body to form the entrance prevention wall.

3. The vacuum valve according to claim 1, wherein
the valve body is provided with a through-hole, the drive shaft penetrating the through-hole and the shaft seal being arranged in the through-hole, and
the entrance prevention wall is provided at a periphery of the through-hole to protrude from the inner peripheral surface of the valve body.

4. The vacuum valve according to claim 2, wherein
a portion of the valve plate fixed to the drive shaft faces an entire area of an end surface of the entrance prevention wall in a protruding direction thereof.

5. The vacuum valve according to claim 3, wherein
a portion of the valve plate fixed to the drive shaft faces an entire area of an end surface of the entrance prevention wall in a protruding direction thereof.
